(19) United States
(12) Patent Application Publication
(10) Pub. No.: US 2022/0107670 A1
(43) Pub. Date: Apr. 7, 2022

(54) INFORMATION PROCESSING DEVICE

(71) Applicant: Panasonic Intellectual Property Management Co., Ltd., Osaka (JP)

(72) Inventors: Masaru FURUJIKU, Osaka (JP); Ryusuke TERAMOTO, Osaka (JP); Munehiro TORII, Osaka (JP); Tatsuo KUROMOTO, Osaka (JP)

(21) Appl. No.: 17/535,749

(22) Filed: Nov. 26, 2021

Related U.S. Application Data
(63) Continuation of application No. PCT/JP2020/021551, filed on Jun. 1, 2020.

(30) Foreign Application Priority Data
Jun. 10, 2019 (JP) 2019-107648

(51) Int. Cl. G06F 1/16

(52) U.S. Cl. CPC G06F 1/1669; G06F 1/1616; G06F 1/1666

(57) ABSTRACT

An information processing device includes a keyboard, a housing including a keyboard storage in a recessed shape in which the keyboard is housed, a flexible cable extending from the keyboard, an adapter attached to a leading end of the flexible cable, a first connector provided in the adapter and electrically connected to the flexible cable, and a second connector provided in the keyboard storage and connected to the first connector. The keyboard storage includes a bottom surface having an adapter fitting part, the adapter fitting part being in a recessed shape and fits with the adapter. The second connector is disposed in the adapter fitting part, and the first connector and the second connector are connected in a direction orthogonal to the bottom surface of the keyboard storage.

### BACKGROUND

### 1. Technical Field

The present disclosure relates to an information processing device including a keyboard.

### 2. Description of the Related Art

For example, Patent Literature (PTL) 1 discloses a laptop personal computer (information processing device) including a keyboard. The keyboard is housed in a recess provided in an upper surface of a housing of the laptop personal computer. The recess is provided in a part of its bottom surface with an opening, and a circuit board in the housing is partially exposed through the opening. The circuit board has the exposed part on which an on-board connector into which a leading end of a flexible flat cable extending from the keyboard is inserted is mounted. The keyboard is waterproof, and a waterproof sheet is disposed between the keyboard and the bottom surface of the recess. The waterproof sheet is provided with a slit through which the flexible flat cable passes.

PTL 1 is Unexamined Japanese Patent Publication No. 2006-99550.

### SUMMARY

For an information processing device including a keyboard, an end user has a need to replace the keyboard.

Thus, an object of the present disclosure is to fabricate a structure in which an end user can easily replace a keyboard in an information processing device including the keyboard.

An information processing device of the present disclosure includes a keyboard, a housing including a keyboard storage in a recessed shape in which the keyboard is housed, a flexible cable extending from the keyboard, an adapter attached to a leading end of the flexible cable, a first connector provided in the adapter and electrically connected to the flexible cable, and a second connector provided in the keyboard storage and connected to the first connector. The keyboard storage includes a bottom surface having an adapter fitting part, the adapter fitting part being in a recessed shape and fits with the adapter. The second connector is disposed in the adapter fitting part, and the first connector and the second connector are connected in a direction orthogonal to the bottom surface of the keyboard storage.

The present disclosure enables an end user to easily replace a keyboard in an information processing device including the keyboard.

### BRIEF DESCRIPTION OF DRAWINGS

FIG. 1 is a front perspective view of an information processing device according to an exemplary embodiment of the present disclosure.

FIG. 2 is a front perspective view of a housing of the information processing device with a keyboard removed.

FIG. 3 is a perspective view of the keyboard.

FIG. 4 is an exploded perspective view of an adapter of the keyboard.

FIG. 5 is a partial perspective view of a housing of the information processing device immediately before the adapter of the keyboard is attached.

FIG. 6 is a partial perspective view of the housing of the information processing device with the adapter of the keyboard attached.

FIG. 7 is a rear perspective view illustrating a keyboard storage in the housing of the information processing device.

### DETAILED DESCRIPTION

An exemplary embodiment will be described below in detail with reference to the drawings as appropriate. However, unnecessarily detailed description may be omitted. For example, the detailed description of already well-known matters and the redundant description of a configuration substantially identical to the already-described configuration may be omitted. A reason for this is to avoid unnecessary redundancy of the following description and to facilitate understanding of those skilled in the art.

The inventors of the present disclosure provide the accompanying drawings and the following description for those skilled in the art to fully understand the present disclosure, and do not provide them to intend to limit the subject matter described in the scope of claims.

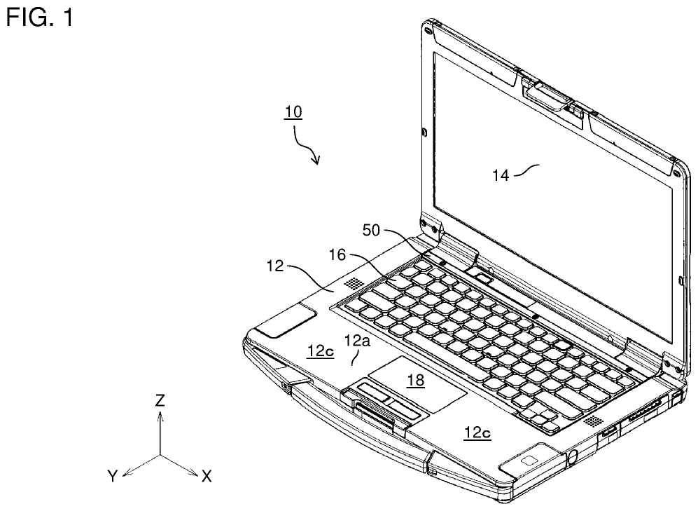

Hereinafter, an information processing device according to an exemplary embodiment of the present disclosure will be described with reference to FIGS. 1 to 7.

FIG. 1 illustrates an information processing device according to an exemplary embodiment of the present disclosure. The drawings each show an X-Y-Z coordinate system that is for facilitating understanding of the exemplary embodiment of the present disclosure, and that does not limit the exemplary embodiment. The X-Y-Z coordinate system includes an X-axis direction that is a width direction of the information processing device, a Y-axis direction that is a depth direction, and a Z-axis direction that is a thickness direction.

As illustrated in FIG. 1, information processing device 10 according to the present exemplary embodiment is a so-called laptop personal computer, and includes housing 12 and display 14 rotatably attached to housing 12.

Housing 12 of information processing device 10 incorporates a central processing unit (CPU), a storage device, and the like, and keyboard 16 is provided on upper surface 12a of housing 12.

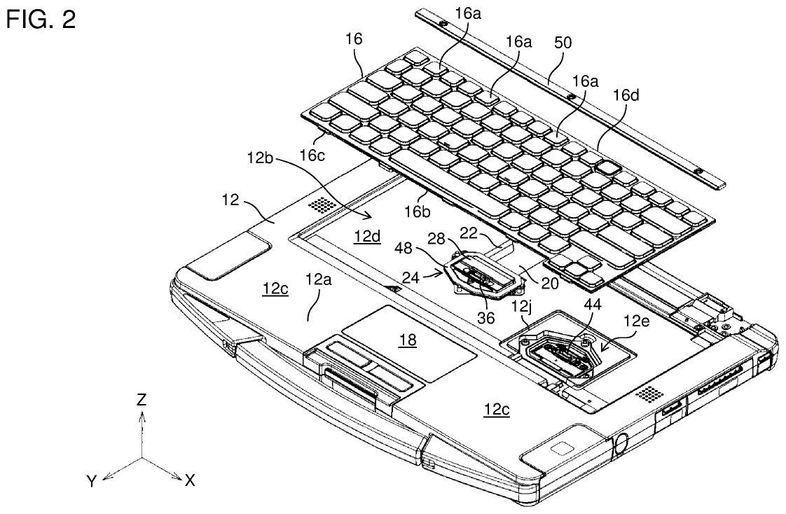

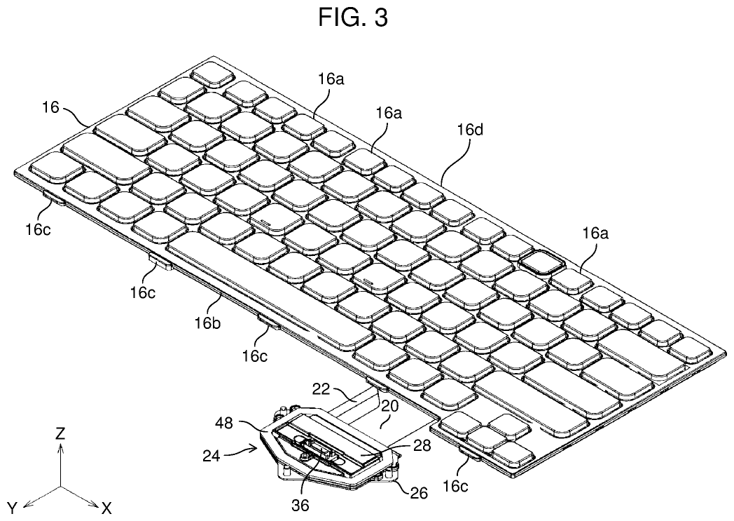

FIG. 2 is a front perspective view of the housing of the information processing device with the keyboard removed. FIG. 3 is a perspective view of the keyboard.

As illustrated in FIG. 2, keyboard 16 is a sheet-like member including a plurality of key tops 16a. For example, keyboard 16 is a membrane-type keyboard. Keyboard 16 of the present exemplary embodiment is required to be drip-proof or waterproof.

As illustrated in FIG. 2, housing 12 is provided in its upper surface 12a with keyboard storage 12b in a recessed shape into which keyboard 16 is fitted and housed. Specifically, keyboard storage 12b is provided in a rear part of upper surface 12a of housing 12. Housing 12 is provided in its front part with palm rest 12c and touch pad 18.

As illustrated in FIG. 3, keyboard 16 of the present exemplary embodiment is provided with two flexible cables 20, 22. One flexible cable 20 is for transmitting a signal from a switch (not illustrated) provided in each of the plurality of key tops 16a to housing 12. Another flexible cable 22 is for supplying power to cause the plurality of key tops 16a to light because a sheet-like backlight is provided in keyboard 16, and key tops 16a transmit light from the backlight. Two flexible cables 20, 22 of the present exemplary embodiment are flexible flat cables and extend from a back surface of keyboard 16.

As illustrated in FIG. 3, two flexible cables 20, 22 each have a leading end to which adapter 24 for connecting keyboard 16 to housing 12 is attached.

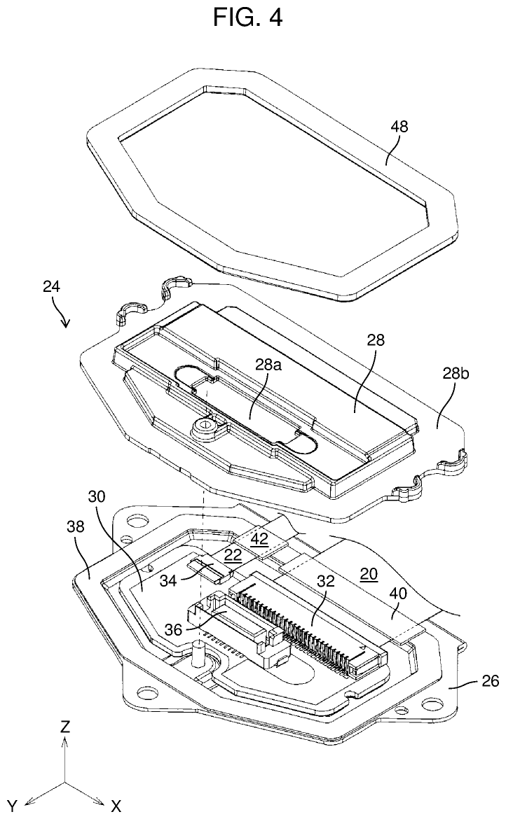

FIG. 4 is an exploded perspective view of the adapter of the keyboard.

As illustrated in FIG. 4, adapter 24 includes top casing 26, bottom casing 28, and circuit board 30. Circuit board 30 is equipped with a plurality of connectors 32, 34, and 36.

As illustrated in FIG. 4, circuit board 30 is housed in a space formed between top casing 26 and bottom casing 28. Top casing 26 and bottom casing 28 of the present exemplary embodiment have respective outer peripheral parts that are bonded to each other with annular waterproof double-sided tape 38 interposed between the outer peripheral parts.

As illustrated in FIG. 4, connector 32 is for flexible cable 20, and a leading end of flexible cable 20 is connected in parallel with the depth direction (Y-axis direction) of housing 12, i.e., circuit board 30.

Connector 34 is for flexible cable 22, and a leading end of flexible cable 22 is connected in parallel with the depth direction (Y-axis direction) of housing 12, i.e., circuit board 30.

Flexible cables 20, 22 respectively connected to connectors 32, 34 extend from between top casing 26 and bottom casing 28 toward keyboard 16. Flexible cables 20, 22 pass through between top casing 26 and bottom casing 28 while being sandwiched between annular waterproof double-sided tape 38 and waterproof double-sided tapes 40, 42, respectively. This causes top casing 26 and bottom casing 28 to be sealed in a fluid-tight manner.

As illustrated in FIG. 2, connector (first connector) 36 is connected to connector (second connector) 44 provided in keyboard storage 12b of housing 12. To enable connection between connector 36 and connector 44 of housing 12, through-hole 28a is formed in bottom casing 28. Connector 36 is electrically connected to connectors 32, 34 for flexible cables 20, 22 through a circuit (not illustrated) formed on circuit board 30.

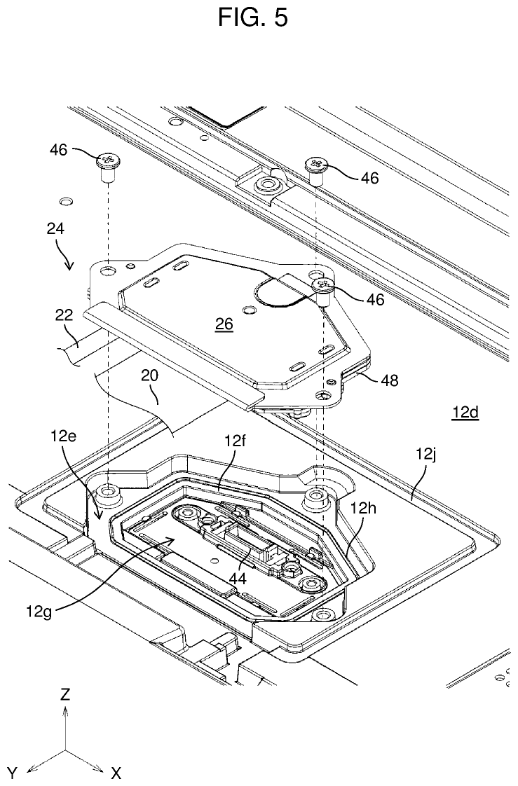

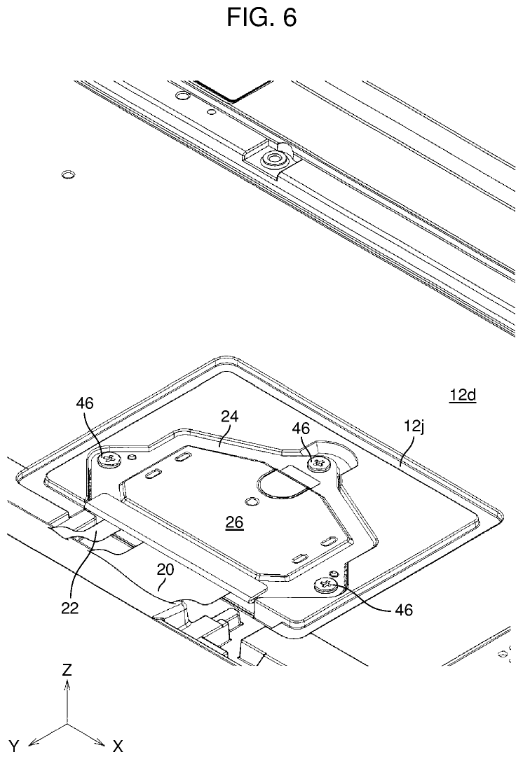

FIG. 5 is a partial perspective view of the housing of the information processing device immediately before the adapter of the keyboard is attached. FIG. 6 is a partial perspective view of the housing of the information processing device with the adapter of the keyboard attached.

As illustrated in FIG. 5, connector 44 on housing 12 is provided on bottom surface 12d of keyboard storage 12b of housing 12.

As illustrated in FIGS. 5 and 6, specifically, keyboard storage 12b is provided in its bottom surface 12d with adapter fitting part 12e that is in a recessed shape and is fitted to adapter 24. Connector 44 is disposed in adapter fitting part 12e. Adapter fitting part 12e of the present exemplary embodiment is provided in its bottom surface 12f with connector housing space 12g in a recessed shape in which connector 44 is disposed.

Connector 44 of housing 12 is electrically connected to a circuit board (not illustrated) mounted inside housing 12 and equipped with a CPU and the like. That is, although connector 44 is located and exposed outside housing 12, the circuit board electrically connected to connector 44 is not exposed outside housing 12. Thus, keyboard 16 can be electrically connected to the circuit board in housing 12 by connecting connector 36 and connector 44 to each other without taking measures against static electricity on the circuit board such as wearing antistatic gloves.

As illustrated in FIG. 5, connector 36 of keyboard 16 and connector 44 of housing 12 are configured to be attached and detached in the thickness direction (Z-axis direction) of housing 12, i.e., in a direction orthogonal to bottom surface 12d of keyboard storage 12b. Thus, connector 36 can be connected to connector 44 by fitting adapter 24 into adapter fitting part 12e in a recessed shape formed in bottom surface 12d of keyboard storage 12b. Adapter 24 of the present exemplary embodiment after being fitted is fixed to housing 12 with a plurality of screws 46 as illustrated in FIG. 6.

Adapter 24 and corresponding adapter fitting part 12e of the present exemplary embodiment have an anisotropic shape for direction when viewed in the thickness direction (Z-axis direction) of housing 12 such that connector 36 of keyboard 16 is connected to connector 44 of housing 12 in a correct orientation. Adapter 24 of the present exemplary embodiment has opposite ends on a front side (a side of touch pad 18) and a back side (a side of display 14) in the depth direction (Y-axis direction) of housing 12, the opposite ends being different in shape.

When adapter 24 is fitted into adapter fitting part 12e as illustrated in FIG. 6, an upper surface of adapter 24, i.e., a front surface of top casing 26 is positioned substantially flush with bottom surface 12d of keyboard storage 12b or at a level lower than bottom surface 12d. This enables keyboard 16 to be placed on bottom surface 12d of keyboard storage 12b.

Connector housing space 12g in a recessed shape in which connector 44 of housing 12 is disposed is covered with adapter 24 fitted into adapter fitting part 12e and placed on bottom surface 12f. As a result, ingress of foreign matters into housing 12 through a gap between connector 44 and housing 12 is prevented.

The present exemplary embodiment also includes seal member 48 to prevent a liquid such as water spilled on keyboard 16 from entering housing 12 through the gap between connector 44 and housing 12.

As illustrated in FIG. 4, seal member 48 has an annular shape and is made of an elastic material such as rubber. When adapter 24 is fitted into adapter fitting part 12e as illustrated in FIG. 6, i.e., when connector housing space 12g is covered with adapter 24, seal member 48 is sandwiched between adapter 24 and bottom surface 12f of adapter fitting part 12e. Then, seal member 48 surrounds connector housing space 12g as viewed in a direction orthogonal to bottom surface 12d of keyboard storage 12b, i.e., as viewed in the Z-axis direction.

Seal member 48 described above has one surface seated on seal seating surface 28b in an annular shape provided on bottom casing 28 of adapter 24. Seal member 48 has the other surface seated on bottom surface 12f of adapter fitting part 12e of housing 12 illustrated in FIG. 5. Seal member 48 described above seals a space between adapter 24 and bottom surface 12f of adapter fitting part 12e to prevent ingress of a liquid into connector housing space 12g through the space. As a result, ingress of a liquid into housing 12 through the gap between connector 44 and housing 12 is prevented.

To further improve waterproof properties, the present exemplary embodiment includes ridge 12h in an annular shape formed at a part of bottom surface 12f of adapter fitting part 12e, on which seal member 48 is seated, as illustrated in FIG. 5. Seal member 48 is seated on bottom surface 12f while covering ridge 12h. This ridge 12h improves sealing properties between seal member 48 and bottom surface 12f as compared to when no ridge 12h is provided. As a result, ingress of a liquid into housing 12 through the gap between connector 44 and housing 12 is further prevented.

To furthermore improve the waterproof properties, the present exemplary embodiment includes groove 12j that at least partially surrounds adapter fitting part 12e and that is provided in bottom surface 12d of keyboard storage 12b as illustrated in FIG. 5. This prevents a liquid such as water spilled on keyboard 16 and having entered keyboard storage 12b from reaching adapter fitting part 12e. As a result, ingress of a liquid into housing 12 through the gap between connector 44 and housing 12 is furthermore prevented.

Hereinafter, a method for attaching keyboard 16 to housing 12 will be described.

As illustrated in FIGS. 5 and 6, adapter 24 is first fitted into adapter fitting part 12e in keyboard storage 12b of housing 12, whereby connector 36 of keyboard 16 and connector 44 of housing 12 are electrically connected. Then, keyboard 16 is placed on palm rest 12c or touch pad 18 of housing 12 with the plurality of key tops 16a facing housing 12, i.e., being turned over.

Such a connection method does not allow adapter 24 and adapter fitting part 12e to be hidden by keyboard 16, so that a user can easily connect connector 36 of keyboard 16 to connector 44 of housing 12.

Next, adapter 24 fitted into adapter fitting part 12e is fixed to housing 12 with the plurality of screws 46, as illustrated in FIG. 6.

Subsequently, flexible cables 20, 22 extending from adapter 24 toward the front of housing 12 are folded back as illustrated in FIG. 6 to disposed keyboard 16 above keyboard storage 12b while the plurality of key tops 16a faces upward.

Subsequently, keyboard 16 is housed in keyboard storage 12b and temporarily fixed.

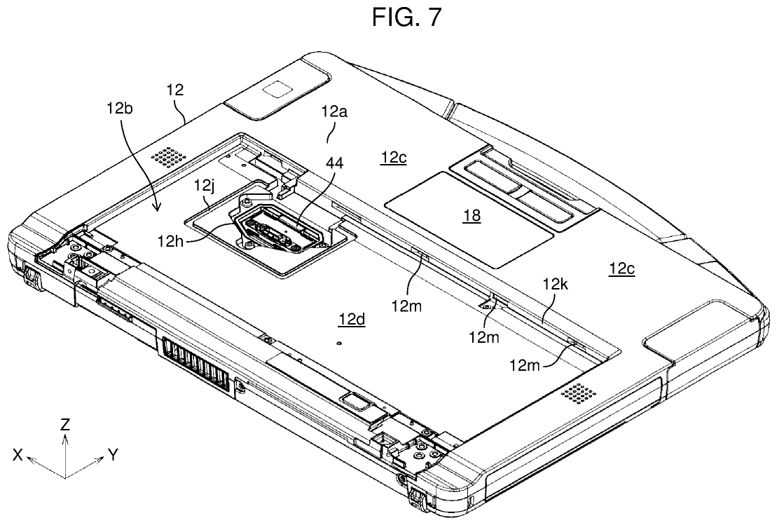

FIG. 7 is a rear perspective view illustrating the keyboard storage in the housing of the information processing device.

As illustrated in FIG. 7, keyboard storage 12b is provided in its side surface 12k on a front side (a side of palm rest 12c) with fitting holes 12m. In contrast, keyboard 16 is provided on its front end 16b with fitting claws 16c to be fitted into corresponding fitting holes 12m as illustrated in FIG. 3.

First, keyboard 16 is brought into an attitude in which front end 16b is directed obliquely downward, and then fitting claws 16c of keyboard 16 are fitted into corresponding fitting holes 12m of housing 12 in the attitude. This causes front end 16b of keyboard 16 to be disposed in keyboard storage 12b. After that, keyboard 16 is brought into a horizontal attitude to dispose rear end 16d of keyboard 16 in keyboard storage 12b. As a result, keyboard 16 is housed in keyboard storage 12b, and then is temporarily fixed to housing 12. That is, front end 16b of keyboard 16 is fixed to housing 12.

After front end 16b of keyboard 16 is fixed to housing 12, rear end 16d is fixed to housing 12. Specifically, rear end 16d of keyboard 16 is held by keyboard back holder 50 in a bar-like shape that is fixed to housing 12 as illustrated in FIG. 2. Rear end 16d of keyboard 16 is fixed to housing 12 by being sandwiched between keyboard back holder 50 and housing 12 in the thickness direction (Z-axis direction) of housing 12. This causes the whole of keyboard 16 to be fixed to housing 12.

To detach keyboard 16, first, keyboard back holder 50 is detached from the housing, and then keyboard 16 is detached from keyboard storage 12b. Subsequently, keyboard 16 is placed on palm rest 12c while being turned over. Then, the plurality of screws 46 are removed to detach adapter 24 from housing 12.

The present exemplary embodiment described above enables an end user to easily replace a keyboard in an information processing device including the keyboard. For example, the end user can easily replace the keyboard as compared to when the leading end of the flexible flat cable extending from the keyboard needs to be inserted into or removed from the on-board connector mounted on the circuit board in the housing.

The present exemplary embodiment enables the end user to easily replace the keyboard while securing the waterproof properties for a liquid such as water spilled on the keyboard.

Although the present disclosure has been described above by taking the above exemplary embodiment as an example, the present disclosure is not limited to the above exemplary embodiment.

For example, although flexible cables 20, 22 connecting keyboard 16 and adapter 24 of the exemplary embodiment described above are flexible flat cables as illustrated in FIG. 3, the exemplary embodiment of the present disclosure is not limited thereto. Any deformable cable even in a wire-like shape may be used as the cable connecting the keyboard and adapter 24.

In a broad sense, an information processing device according to an exemplary embodiment of the present disclosure includes a keyboard, a housing including a keyboard storage in a recessed shape in which the keyboard is housed, a flexible cable extending from the keyboard, an adapter attached to a leading end of the flexible cable, a first connector provided in the adapter and electrically connected to the flexible cable, and a second connector provided in the keyboard storage and connected to the first connector. The keyboard storage is provided in its bottom surface with an adapter fitting part that is in a recessed shape and fits with the adapter. The second connector is disposed in the adapter fitting part, and the first and second connectors are connected in a direction orthogonal to the bottom surface of the keyboard storage.

As described above, the plurality of exemplary embodiments has been described as examples of the technique in the present disclosure. To this end, the accompanying drawings and detailed description are provided.

Thus, the components described in the accompanying drawings and detailed description include not only components essential for solving the above problem, but also components that are not essential. Consequently, when those non-essential components are described in the accompanying drawings and detailed description, the non-essential components should not be immediately acknowledged to be essential based on only the description.

The exemplary embodiments described above are intended to illustrate the technique in the present disclosure, and thus various changes, replacements, additions, eliminations, and the like may be made within the scope of claims and equivalents thereof.

The present disclosure is applicable to an information processing device including a keyboard.

What is claimed is:

1. An information processing device comprising:
a keyboard;
a housing including a keyboard storage in a recessed shape in which the keyboard is housed;
a flexible cable extending from the keyboard;
an adapter attached to a leading end of the flexible cable;
a first connector provided in the adapter and electrically connected to the flexible cable; and
a second connector provided in the keyboard storage and connected to the first connector,
wherein
the keyboard storage includes a bottom surface having an adapter fitting part, the adapter fitting part being in a recessed shape and fits with the adapter,
the second connector is disposed in the adapter fitting part, and
the first connector and the second connector are connected in a direction orthogonal to the bottom surface of the keyboard storage.

2. The information processing device according to claim 1, wherein the adapter has an anisotropic shape for direction when viewed in the direction orthogonal to the bottom surface of the keyboard storage.

3. The information processing device according to claim 1, wherein the adapter fitting part includes a bottom surface having a connector housing space, the connector housing space being in a recessed shape in which the second connector is disposed, the connector housing space being covered with the adapter fitted into the adapter fitting part.

4. The information processing device according to claim 3, further comprising
an annular seal member that is sandwiched between the adapter and the bottom surface of the adapter fitting part and surrounds the connector housing space when viewed in the direction orthogonal to the bottom surface of the keyboard storage.

5. The information processing device according to claim 4, wherein the bottom surface of the adapter fitting part includes a ridge in an annular shape on which the annular seal member is seated.

6. The information processing device according to claim 1, wherein the bottom surface of the keyboard storage includes a groove that at least partially surrounds the adapter fitting part.

7. The information processing device according to claim 1, further comprising
a display rotatably attached to the housing, wherein the information processing device is a laptop personal computer.
